(19) United States
(12) Patent Application Publication
(10) Pub. No.: US 2007/0177011 A1
(43) Pub. Date: Aug. 2, 2007

(54) Movement control system

(76) Inventors: Andrew C Lewin, Malvern (GB); Simon C Woods, Malvern (GB); David A Orchard, Malvern (GB)

Correspondence Address: NIXON & VANDERHYE, PC, 901 NORTH GLEBE ROAD, 11TH FLOOR, ARLINGTON, VA, 22203, US

(21) Appl. No.: 10/589,498

(22) PCT Filed: Mar. 4, 2005
(86) PCT No.: PCT/GB05/00843

§ 371 Date: Aug. 15, 2006

(30) Foreign Application Priority Data
Mar. 5, 2004 (GB) 0405014.2

(51) Int. Cl. H04N 7/18

(52) U.S. Cl. 348/118; 348/135

(57) ABSTRACT

The present invention relates to a movement control system which can be used to control moving platforms such as vehicles or robotic arms. It especially applies to a driving aid for vehicles and to a parking aid capable of self-parking a vehicle.

A three-dimensional camera (12) is located on the platform, say a car (102) and arranged to view (114) the environment around the platform. A processor (7) uses the three-dimensional information to create a model of the environment which is used to generate a movement control signal. Preferably the platform moves relative to the environment and acquires a plurality of images of the environment from different positions.

This invention relates to movement control aids for vehicles or robotic systems, especially to automated control systems such as automated parking systems for vehicles, docking control and object manipulation systems.

There is an ongoing desire to provide and improve movement control systems in a wide range of applications from improving proximity sensors for vehicles, to automated control systems for vehicles or control of robotic systems.

Thus according to the present invention there is provided a movement control system comprising at least one three-dimensional imaging system adapted to image an environment and a processor for analysing the image so at to create a model of the environment and generate a movement control signal based on the created model wherein the three-dimensional imaging system comprises an illumination means for illuminating a scene with a projected two dimensional array of light spots, a detector for detecting the location of spots in the scene and a spot processor adapted to determine, from the detected location of a spot in the scene, the range to that spot.

Thus the present invention relates to a movement control system comprising at least one three dimensional imaging system adapted to image an environment and a processor for analysing the image so at to create a model of the environment and generate a movement control signal based on the created model.

The three-dimensional imaging apparatus is one which acquires range information to the plurality of spots projected onto the scene, in effect a two dimensional array of range values. This three dimensional image can be acquired with, or without, intensity information from the scene, i.e. a usual image as might be taken by a camera system. The three-dimensional imaging system acquires one or more three dimensional images of the environment and uses these images to create a model of the environment from which a movement control signal can be generated. As the three dimensional imaging system projects an array of spots it is good at determining range to surfaces, even generally featureless surfaces.

Conveniently the at least one three-dimensional imaging apparatus is adapted to acquire three dimensional images of the environment at a plurality of different positions and the processor is adapted to process images from the different positions so as to create the model of the environment.

Recording three-dimensional images of the environment at a plurality of positions effectively scans the environment to provide more information. This can remove the effects of shadowing, where a part of the foreground obscures the background from a particular viewpoint. Also where the environment in question is relatively large a single view may not provide accurate enough information.

Preferably the processor is also adapted to apply stereo image processing techniques to images from different positions in creating the model of the environment. Stereo image processing techniques are known in the art and rely on two different viewpoints of the same scene. The parallax between identified objects in the scene can give information about the relationship of objects in the scene. Stereo processing techniques are very useful for identifying the edges of objects in the scene as the edges are clear features that can be identified from the parallax between images. Stereo imaging however generally provides little information about any variations in range of a continuous surface. By contrast spot projection based three dimensional imaging systems determine the range to each detected spot and so give lots of information about surfaces but can only identify the presence of a range discontinuity, i.e. edge, between two detected spots and not its exact location. An exact edge location may be needed if manipulation of an object is intended. Thus the stereo imaging can be used to identify the edges and corners of objects in the scene and the range information from the three dimensional imaging system can be used to fill out the contours of the surfaces of any objects. Thus using three-dimensional imaging together with stereo imaging techniques lots of information regarding the location of objects in an environment can be generated and used to form a model of the environment.

As mentioned stereo image processing techniques can be very useful and can be achieved with a single imager using frame to frame stereo imaging, for instance the separation between viewpoints being provided by motion of the platform on which the movement control system is mounted or by a deliberated scan of the three imaging system. For a road vehicle the direction of movement is horizontal and it may be advantageous to have stereo imaging in the vertical direction too, for instance to resolve kerbs etc.

However the advantage of at least two viewpoints is such that preferably the system comprises at least two imaging apparatuses arranged to look toward the same part of the environment from different viewpoints. Thus even without motion of the three dimensional imager relative to the scene, for instance as would be the case when a vehicle is first started and there is no motion history available, the different imaging apparatuses have different viewpoints and stereo data is also available. Of course motion of the imaging system relative to the scene may generate other frame to frame stereo views that can be used in generating the model of the scene. There may be three imaging apparatuses arranged to look towards the same part of the environment from different viewpoints not on the same axis. Conveniently the axis of separation of at least two of the imaging apparatuses may be different, say substantially orthogonal, to the usual direction of motion of a vehicle on which they are mounted.

The movement control signal generated will depend upon the application to which the present invention is applied and could be simply an information or warning signal to an operator or could allow direct control of a moveable object.

For instance the movement control system could be implemented on a vehicle to provide safety or warning information. For instance a three dimensional imaging system could be located at or near the extremity of a vehicle and could provide information about how close the vehicle is to other objects. A road vehicle such as a car could have a three dimensional imaging sensor constantly determining the range to other vehicles and stationary objects to provide a warning should another vehicle come too close or even provide some safety action such as applying the brakes or even steering the vehicle. Preferably the vehicle would be provided with a plurality of three-dimensional imaging systems, each imaging system arranged to image the environment in the vicinity of an extremity of the vehicle and/or any blind spots of the vehicle, e.g. a car could have an imaging system provided in the vicinity of each corner, for instance embedded into the light clusters. Each imaging system could have its own processor or they could share a common processor. Alternatively or additionally the movement control system could be activated in certain situations such as parking. The information from the model of the environment, such as the parking space or garage, could be used to give indications of how close the vehicle is to another object. The indications could be audible or visible or both. The system could also be mounted on an aircraft to monitor the extremities of the aircraft, for instance the wingtips in a fixed wing aircraft. Aircraft manoeuvring on the ground need to be careful not to collide with objects at an airport Again the control signal could be a warning signal to the flight crew and/or ground crew or the control system could take preventative measures to avoid collision. The system could equally be utilised to optimise docking procedures such as for aircraft passenger walkways, in-flight refuelling, space platforms etc. or for robotic arm control systems which control how the arm manipulates objects in the environment, e.g. for grasping or stacking objects.

The movement control system could also provide some degree of automated control of the vehicle. Vehicles could be provided with self navigation systems, for instance robotic systems having self navigation. Vehicles could be provided with self positioning systems—the images from the three dimensional imager or imagers being used to create a model of the environment with the control signal directing a series of controlled movements of the vehicle to position the vehicle accordingly. For instance a car could be provided with a parking system to allow parking of the car or a fork lift truck or similar may be automated and the movement control system could allow the fork lift truck to accurately position itself in relation to an object to be picked up or in relation to a space in which to deposit a carried item.

The movement control system could also be implemented on a moving object which is not a vehicle, such as a robotic arm. Robotic arms are often used on production lines where objects are found in a predetermined location relative to the arm. However to account for variations in object location or to allow very accurate interfacing between the arm and the object it may be necessary to adjust the arm position in each case. Indeed allowing the arm controller to form a model of an environment in a automated flow through process may allow automation of task presently unsuitable for automation, e.g. sorting of waste perhaps for recycling purposes. Moveable arms are also provided on other platforms for remote manipulation of objects, e.g. bomb disposal or working in remote or hazardous environments. To provide for multiple viewpoints to generate full data about the environment the robotic arm, or at least part thereof, could be moved to scan the three dimensional imaging system with regard to the environment.

Preferably the system also includes a means of determining the relative location of the three-dimensional imaging apparatus when a range image is acquired and the processor uses the information about relative location in creating the model. In order to create the model from the various images the processor needs to know how all the images relate to the environment. Generally this involves knowing where the imaging system was for a particular acquired image relative to the other images. The movement control system could be adapted to acquire images only at certain relative positions—for instance a robotic arm may be provided with a movement control system according to the present invention and the arm may be adapted to move to certain predetermined positions to acquire the images. Thus the relative position of the imaging system is predetermined. In other applications however the relative positions at which images are acquired will not be predetermined and so it will be necessary to monitor the relative location or acquire information about the relative positions of the images by identifying common reference features in the scene.

The relative location could be achieved by providing the movement control system with a location monitor. For instance a GPS receiver could be included or location sensors that determine location relative to a fixed point such as a marker beacon etc. The location sensors could include compasses, magnetic field sensors, accelerometers etc. The skilled person would be aware of a variety of ways of determining the location of the imaging system for each image.

Alternatively the relative location could be determined by monitoring travel of the platform on which the movement control system is mounted. On a vehicle such as a car the motion of the wheels is already monitored for speed/distance information. This could be coupled into a simple inertial sensor to provide relative location information. Indeed if the movement control apparatus is only used in situations where the vehicle is travelling in a straight line the distance travelled alone will be sufficient to determine the relative motion. For some applications this will be sufficient—for example the system could be used as a parking system. The driver could activate the movement control system and drive past the parking space. The three dimensional imaging apparatus would capture a number of images of the space as the vehicle passed by and generate a model of the space. The movement control signal could then comprise a set of instructions on how to best manoeuvre into the space. These instructions could be relayed to the driver by some means, e.g. visual or aural aids, or the parking could be automated and the movement control signal could be used by an automatic drive unit to position the vehicle. Such a system could find application on a wide range of vehicles, e.g. it would be employed to park aircraft or position lifting vehicles such as fork-lift trucks.

In another aspect of the invention there is therefore provided a vehicle positioning system comprising a three dimensional imaging apparatus arranged to acquire a plurality of three dimensional images of a target area as the vehicle moves in respect to the target area and a processor adapted to process the images from the different positions so as to create the model of the environment and determine how to position the vehicle with respect to the target area.

The target area may be a parking space and the vehicle may pass the parking area to acquire the images in which case the processor determines how to park the vehicle in the parking area. Thus a driver wanting to park a vehicle may activate the parking system and drive past the space in which it is wished to park. The three-dimensional imaging apparatus takes a series of images of the parking space and the processor builds a model of the space and the position of the vehicle and determines how best to park to vehicle. The system may comprise a user interface which could be used to relay parking instructions. For instance the interface could be a computer generated speech unit giving instructions on when to reverse, when and how to steer, when to step etc. Additionally or alternatively a visual display could be used to display the vehicles location relative to the space and objects and give parking instructions.

The system could comprise a drive unit for automatically moving the vehicle and the processor could control the drive unit to move the vehicle into the space. Before moving the interface could present a display of proposed movement or some parking options so that the driver is confident that the vehicle is going to park correctly.

In either case, whether the driver is guided by the processor via the interface or vehicle parks automatically the model of the environment is constantly updated. This is necessary in case a pedestrian steps into the parking area or a parked vehicle starts to move but in addition the constant monitoring also allows the model to be refined and the parking instructions updated as necessary. Where the driver is actually controlling the vehicle in parking and receiving instructions from the parking aid the model needs updating to take account of what the driver actually does as it will rarely be exactly what was suggested.

Alternatively the vehicle could be an object moving device such as a fork lift truck and the target area could either be a location to pick up on object or an area where it is wished to stack or deposit an object. In which case the vehicle could pass be the area to determine how best to left or deposit the item and then act accordingly, again either via instructions to an operator or automatically.

It should be noted that any type of vehicle could be equipped with the control system according to the present invention. For instance aircraft moving around an airport need to be parked at the correct gate position on landing or moved into hangars for storage or maintenance. Lorries could benefit for a parking control system to allow accurate alignment to loading bays.

The present invention also relates to a method of generating instructions for positioning a vehicle comprising the steps of moving the vehicle past a target area and recording three-dimensional images of the target area from a plurality of different positions, processing the three-dimensional images to create a model of the target area relative to the vehicle and based on the model calculating how to position the vehicle as required with respect to the target area. The method preferably involves using stereo imaging technique on the three-dimensional images acquired from different viewpoints in creating the model. The method may comprise the additional step of relaying instructions to a vehicle operator via an interface or may include the step of operating a drive unit to automatically position the vehicle. The vehicle may be a car and the method may be a method of generating a set of parking instructions.

As mentioned the invention is not just applicable to parking and can aid general driving. In another aspect then there is provided a vehicle driving aid comprising a movement control system as described above wherein at least one 3D imager is adapted to image a vehicle blind spot and the movement control signal is a warning that an object has entered the vehicle blind spot. The vehicle blind spot could be any part of the environment around a vehicle which the driver can not see or see easily, for instance areas not revealed by looking in wing mirrors or areas which are obscured by part of the vehicle.

In general the invention is applicable to any moving object which needs to be accurately or safely positioned with respect to an object or gap. As mentioned robotic arms on production lines that show some variability may need to accurately interface with objects on the line. Remote vehicles or those operating in hazardous environments may also need to interface with objects, e.g. underwater vessels or space vehicles or robotic vehicles such as used in explosive ordinance disposal.

Thus in another aspect there is provided a docking control system for a moveable platform comprising a three-dimensional imaging apparatus arranged acquire three dimensional images of an environment from a plurality of different positions and a processor adapted to process the images from the different positions so as to create the model of the environment in relation to the moveable platform and provide a control signal to a drive means of the moveable platform so as to dock the moveable platform with the environment.

As used herein the term dock should be read broadly to mean to position the moveable platform in accurate location with a desired part of the environment, e.g. to grasp an object with a robotic arm, locate a fork-lift to engage with a pallet, position a vehicle in a garage etc. The moveable platform could be any moveable object such as a vehicle or moveable arm. The present invention also therefore relates to a robotic arm control unit comprising a three-dimensional imaging apparatus arranged acquire three dimensional images of an environment from a plurality of different positions and a processor adapted to process the images from the different positions so as to create the model of the environment in relation to the moveable platform and provide a control signal to a drive means of the robotic arm to either engage an object or accurately place an object. This aspect of the invention therefore provides control for a ‘pick and place’ robotic arm which is capable of engaging with objects, for instance to lift in a safe manner and accurately place them, for instance positioning objects in a substrate. The present invention allows for variations in position of an object or substrate from one piece to another on an assembly line and ensures that the arm picks up the object in the right way and accurately positions the object with respect to the substrate—thus avoiding accidental damage and giving better alignment.

Developing a full three dimensional model of the environment may not be required at all times or for all operations. For instance imagine an automated vehicle for moving object between locations, say an automated fork lift truck. When moving between locations, say a particular location in a warehouse and a loading bay, the vehicle may move according to predetermined instructions and movement control is provided by position monitoring means, e.g. laser guidance, onboard GPS etc. When the vehicle is moving between locations a full model of the environment may not be required. Nevertheless a proximity sensor of some sort may be needed as a collision avoidance system to detect people or debris in the path of vehicle. Once the vehicle has reached the location in the warehouse where it is needed to pick up or stack/deposit an object then full information about the target area may be required so that the object can be picked up or stacked correctly. Therefore in another aspect of the invention there is provided a movement control means for a vehicle operable in two modes, a movement mode in which a proximity sensor operates to detect any objects within the path of the vehicle, and an interaction mode in which a three dimensional ranging means determines range information about a target area to form a model of the target area.

Therefore in movement mode the movement control means effectively monitors the path the vehicle is moving on for a short distance ahead to ensure that the vehicle does not collide with a person or an obstacle on that path. Using a simple proximity sensor means that processing is very fast and simple—is something in the way or not. The range in which to detect obstacles will in part by determined by the vehicle speed and the need to prevent collision but for an automatic fork lift truck or the like may be a few tens of centimetres.

Once the vehicle arrives at its destination, the target area, it switches to interaction mode. Here a three dimensional range means acquires range information about the target area in order to form a model of the target area. Preferably the ranging means is a three dimensional imaging means as described above with respect to other aspects of the invention. Once a model of the area has been acquired the movement control means may then control the vehicle to perform a predetermined task, such as acquiring the uppermost box in a stack or deposit an object onto a stack. In order to form a good model of the target area the three dimensional imaging means in interaction mode may acquire more than one viewpoint of the target area. All of the embodiments and advantages of the other aspects of the invention may be applied to this aspect of the invention when in interactive mode.

When in movement mode if an obstacle is detected various strategies to navigate the obstacle could be employed. For instance the vehicle could halt and wait to see if the obstacle moves—for instance a person or other vehicle moves out of the way—or it could have a set movement pattern, e.g. to the side, to determine whether there is a navigable path past a static obstacle. It could also use an alternative route to its destination if available. Alternatively the movement control system could switch to interactive mode to navigate the obstacle.

The proximity sensor may be any type of proximity sensor which is fast enough for the expected vehicle speeds and has good enough range and area coverage. More than one proximity sensor may be used at different parts of the vehicle.

In one embodiment however the three dimensional imaging means is also used as a proximity sensor. However rather than process all range information to determine a full range profile the three dimensional range system could be operated in a proximity sensor mode to simplify, and therefore speed, processing.

PCT patent application publication WO 2004/044619 describes a proximity sensor based on a three dimensional spot projection system such as described previously. In such a proximity sensor a projector array projects an array of spots and a detector detects any spots in the scene. Between the detector and the scene is a mask having at least one aperture so that the detector only sees part of the scene. A spot will only be visible to the detector if it appears in part of the scene which can be seen through the mask and the arrangement is such that this corresponds to a certain range band. Therefore detection of a spot means that an object is within a certain range band and absence of a spot means there is nothing within that range band. Thus the detection or otherwise of a spot can be a very simple indication of the presence or otherwise of an object within a certain range band. For instance the three dimensional imaging system could be mounted on top of the vehicle and directed to look at the area in front of the vehicle and the visible range band could correspond to the expected floor level in front of the vehicle. In such an arrangement were the floor in front of the vehicle level and unobstructed the detector would see spots through the apertures. Were however there to be a hole in the floor or an object on the floor (or indeed anywhere within the line of projection of the spot projector) then the range to the reflected spot would change and so the spot would move to a part of the scene which is masked. The disappearance of a spot would then be indicative of an obstacle. An additional three dimensional imaging system could be arranged at floor level looking along the direction of motion and could be arranged so that for a clear path no spots are detected but a spot appearing in an unmasked part of the detector array is indicative of an object within a certain range in front.

The simple detection of the appearance or disappearance of a spot can be determined rapidly using minimal processing power.

The present invention could therefore use a three dimensional imaging system which can removably introduce a mask into the optical path to the detector. For instance a spatial light modulator such as an LCD could be switched to and from a transmissive state in interactive mode, where full processing of all spots is required, and a state where a mask pattern in displayed in movement mode. Alternatively there may be no physical mask and the mask effectively applied by processing the detector output. For instance a bitmap pattern corresponding to the mask could be applied to the detector outputs to remove any output from a notionally masked part of the detector array. This would be an easy processing step and would result in an output corresponding only to the notionally unmasked portions of the display which again could be monitored simply for a chance in intensity etc.

The three-dimensional imaging system used in any of the above aspects of the invention preferably needs to provide accurate range information to a high resolution in the scene in real time. Ideally the three-dimensional imaging system is compact and is relatively inexpensive.

As mentioned previously the illumination means illuminates the scene with an array of spots. The detector then looks at the scene and the spot processor, which may or may not be the same processor that creates the model of the environment, determines the location of spots in the detected scene. The apparent location of any spot in the array will change with range due to parallax. As the relationship of the detector to the illumination means is known, the location in the scene of any known spot in the array can yield the range to that point.

Of course, to be able to work out the range to a spot, it is necessary to know which spot in the array is being considered. Prior art ranging system using structured illumination have previous used single spot systems—where there is only one spot in the scene and so there is no difficulty. Some systems have used linear beams but even when using a linear beam the beam is projected so as to be parallel to one direction, say the y-direction. For each value in the y-direction then the actual x-position in the scene can then be used to determine the range.

Were a two dimensional array of spots to be used however the spots would be distributed in both the x and y directions. The skilled person would therefore not be inclined to use a two dimensional array of spots as they would have thought that this would have meant that the ranging system would either be unable to determine which spot was which and hence could not perform ranging or would produce a result that could suffer from errors if the wrong spot had been considered. Some prior art system have projected a two dimensional array of spots but only in instances with a narrow operating range, where no ambiguity is likely to result, or with known types of continuous objects. The imaging system used in the present invention allows use of a two dimensional array of spots for simultaneous ranging of a two-dimensional scene of unknown objects over a wide operating range and uses various techniques to avoid ambiguity over spot determination. Preferably the three dimensional imaging system used is that described in PCT patent application publication WO 2004/044525.

As used herein the term array of spots is taken to mean any array which is projected onto the scene and which has distinct areas of intensity. Generally a spot is any distinct area of high intensity radiation and may, as will be described later, be adapted to have a particular shape. The areas of high intensity could be linked however provided that the distinct spot can be identified. For instance the illumination means may be adapted to project an array of intersecting lines onto the scene. The intersection of the lines is a distinct point which can be identified and is taken to be a spot for the purposes of this specification.

Conveniently the illumination means and detector are arranged such that each spot in the projected array appears to move in the detected scene, from one range to another, along an axis and the axis of apparent motion of each adjacent spot in the projected array is different. As will be explained later each spot in the array will appear at a different point in scene depending upon the range to the target. If one were to imagine a flat target slowly moving away from the detector each spot would appear to move across the scene. This movement would, in a well adjusted system used in certain applications, be in a direction parallel to the axis joining the detector and illumination means, assuming no mirrors etc. were placed in the optical path of the detector or illumination means. Each spot would however keep the same location in the scene in the direction perpendicular to this axis. For a different arrangement of illumination means and detector the movement would appear to be along generally converging lines.

Each projected spot could therefore be said to have a locus corresponding to possible positions in the scene at different ranges within the operating range of the system, i.e. the locus of apparent movement would be that part of the axis of apparent motion at which a spot could appear, as defined by the set-up of the apparatus. The actual position of the spot in the detected scene yields the range information. Where the apparent direction of movement of a spot at various ranges happens to be the same as for another spot then the loci corresponding to the different spots in the projected array may overlap. In which case the processor would not be able to determine which spot in the projected array is being considered. Were the loci of spots which are adjacent in the projected array to overlap, measurement of the location in the scene of a particular spot could correspond to any of a number of different ranges with only small distances between the possible ranges. For example, imagine the array of spots was a two dimensional array of spots in an x-y square grid formation and the detector and illumination means were spaced apart along the x-axis only. Using Cartesian co-ordinates to identify the spots in the projected array with (0,0) being the centre spot and (1,0) being one spot along the x-axis, the location in the scene of the spot at position (0,0) in the projected array at one range might be the same as the position of projected spot (1, 0) at another slightly different range or even projected spot (2,0) at a slightly different range again. The ambiguity in the scene would therefore make range determination difficult.

Were however the detector and illumination means arranged such that the axis between them was not parallel to either the x-axis or the y-axis of the projected array then adjacent spots would not overlap. Ideally the locus of each spot in the projected array would not overlap with the locus of any other spot but in practice with relatively large spots and large arrays this may not be possible. However, if the arrangement was such that the loci of each spot only overlapped with that of a spot relatively far removed in the array, then although ambiguity would still be present the amount of ambiguity would be reduced. Further the difference in range between the possible solutions would be quite large. For example the range determined were a particular projected spot, (0,4) say, to be detected at one position in the scene could be significantly different from that determined if a spot removed in the array (5,0) appeared at the same position in the scene. In some applications the operating range may be such that the loci corresponding to the various possible locations in the scene of the spots within the operating window would not overlap and there would be no ambiguity. Even where the range of operation would allow the loci of spots to overlap the significant difference in range could allow a coarse estimation of range to be performed to allow unique determination of which spot was which with the location of each spot in the scene then being used to give fine range information.

One convenient way of determining coarse range information involves the illumination means and detector being adapted such that a projected array of spots would appear sharply focussed at a first distance and unfocussed at a second distance, the first and second distances being within the operating range of the apparatus. The spot processor is adapted to determine whether a spot is focussed or not so as to determine coarse range information. For example if a detected spot could correspond to projected spot (0,4) hitting a target at close range or projected spot (5,0) hitting a target at long range the spot processor could look at the image of the spot to determine whether the spot is focussed or not. If the illumination means and detector were together adapted such that the spots were focussed at long range the determination that the spot in question was focussed would mean that the detected spot would have to be projected spot (5,0) hitting a target at long range. Had an unfocussed spot been detected this would have corresponded to spot (0,4) reflected from a target at close range. Preferably in order to ease identification of whether a spot is focussed or not the illumination means is adapted to project an array of spots which are non-circular in shape when focussed, for instance square. An in focus spot would then be square whereas an unfocussed spot would be circular. Of course other coarse ranging methods could be used—the size of a spot could be used as an indication of coarse range.

As an additional or alternative method of resolving possible ambiguity the illumination means could be adapted to periodically alter the two dimensional array of projected spots, i.e. certain spots could be turned on or off at different times. The apparatus could be adapted to illuminate the scene cyclically with different arrays of spots. In effect one frame could be divided into a series of sub-frames with a sub-array being projected in each sub-frame. Each sub-array would be adapted so as to present little or no range ambiguity in that sub-frame. Over the whole frame the whole scene could be imaged in detail but without ambiguity.

An alternative approach could be to illuminate the scene with the whole array of spots and identify any areas of ambiguity. If a particular detected spot could correspond to more than one projected spot at different ranges, one or more of the possible projected spots could then be deactivated so as to resolve the ambiguity. This approach may require more processing but could allow quicker ranging and would require a minimum of additional sub-frames to be acquired to perform ranging.

Additionally or alternatively the illumination means may be adapted so as to produce an array of spots wherein at least some projected spots have a different characteristic to their adjacent spots. The different characteristic could be colour or shape or both. Having a different colour or shape of spot again reduces ambiguity in detected spots.

Although the loci of different spots may overlap, and there may be some ambiguity purely based on spot location in the scene, if the projected spots giving rise to those loci are different in colour and/or shape the spot processor would be able to determine which spot was which and there would be no ambiguity. The detector and illumination means are therefore preferably arranged such that if the locus of one projected spot does overlap with the locus of one or more other projected spots at least the nearest projected spots having a locus in common have different characteristics.

As mentioned above a preferred embodiment of the present invention images the scene from more than one viewpoint and may use the data from the multiple viewpoints in determining range. For instance there may be ambiguity in the actual range to a spot detected in the scene from a first viewpoint. The particular spot could correspond to a first projected spot in the array reflected from a target at a first range or a second (different) projected spot in the array reflected of a target at a second (different) range. These possibilities could then be tested by looking at the data from the other viewpoint. If a particular spot as detected from the other viewpoint would correspond to the second projected spot reflected from the target at the second range but there is no spot detected from the second viewpoint which corresponds to the first projected spot in the array reflected from a target at the first range then the ambiguity is removed and the particular spot identified—along with the range thereto. Additionally or alternatively range information from stereo processing techniques could be used in spot identification.

As mentioned above the spots may comprise intersections between continuous lines. The detector can then locate the spots, or areas where the lines intersect, as described above. Preferably the illumination means projects two sets of regularly spaced lines, the two sets of lines being substantially orthogonal.

Using intersecting lines in this manner allows the detector to locate the position of the intersection points in the same manner as described above. Once the intersection points have been found and identified the connecting lines can also be used for range measurements. In effect the intersection points are used to identify the various lines in the projected array and once so identified all of the points on that line can be used to give range information. Thus the resolution of the range finding apparatus can be improved over that using only separated spots.

The detector is conveniently a two dimensional CCD array, i.e. a CCD camera. A CCD camera is a relatively cheap and reliable component and has good resolution for spot determination. Other suitable detectors would be apparent to the skilled person however and would include CMOS cameras.

Conveniently the illumination means is adapted such that the two dimensional array of spots are infrared spots. Using infrared radiation means that the spots do not affect the scene in the visible range. The detector may be adapted to capture a visible image of the scene as well as the location of the infrared spots in the scene. However the wavelength of the illumination means can be tailored to any particular application. For instance for use underwater a wavelength that is not strongly absorbed in water is used, such as blue light.

The length of the baseline between the detector and the illumination means determines the accuracy of the system. The term baseline refers to the separation of the line of sight of the detector and the line of sight of the illumination means as will be understood by one skilled in the art. As the skilled person will understand the degree of apparent movement of any particular spot in the scene between two different ranges will go up as the separation or baseline between the detector and the illumination means is increased. An increased apparent movement in the scene between different ranges obviously means that the difference in range can be determined more accurately. However equally an increased baseline also means that the operating range in which there is no ambiguity is also reduced.

The baseline between the detector and the illumination means is therefore chosen according to the particular application. For a ranging apparatus intended to work over an operating distance of say 0.5 m to 2.0 m, the baseline of the detector and the illumination means is typically approximately 60 mm.

It should be noted that whilst the baseline of the apparatus will often be the actual physical separation between the detector and the illumination means this will not necessarily always be the case. Some embodiments may have mirrors, beam splitters etc in the optical path of one or both of the illumination means and the scene. In which case the actual physical separation could be large but by use of appropriate optical components the apparent separation or baseline, as would be understood by one skilled in the art, would still be small. For instance the illumination means could illuminate the scene directly but a mirror placed close to the illumination means could direct received radiation to the detector. In which case the actual physical separation could be large but the apparent separation, the baseline, would be determined by the location of the mirror and the detector, i.e. the position the detector would be if there were no mirror and it received the same radiation. The skilled person would understand that the term baseline should be taken as referring to the apparent separation between the detector and the illumination means.

As mentioned above it is preferable that the imaging system image the projected spot array from more than one viewpoint. The detector means may therefore be adapted to image the scene from more than one direction. The detector could be either moveable from one location to another location so as to image the scene from a different viewpoint or scanning optics could be placed in the optical path to the detector so as to periodically redirect the look direction. Both of these approaches require moving parts however and mean that the scene must be imaged over sub-frames. As an alternative the detector may comprise two detector arrays each detector array arranged so as to image the scene from a different direction. In effect two detectors (two cameras) may be used each imaging the scene from a different direction, thus increasing the amount and/or quality of range information.

As mentioned above imaging the scene from more than one direction can have several advantages. Obviously objects in the foreground of the scene may obscure objects in the background of the scene from certain viewpoints. Changing the viewpoint of the detector can ensure that range information to the whole scene is obtained. Further the difference between the two images can be used to provide range information about the scene. Objects in the foreground will appear to be displaced between the two images than those in the background. This could be used to give additional range information. Also, as mentioned, in certain viewpoints one object in the foreground may obscure an object in the background—this can be used to give relative range information. The relative movement of objects in the scene may also give range information. For instance objects in the foreground may appear to move one way in the scene moving from one viewpoint to the other whereas objects in the background may appear to move the other way. The processor therefore preferably applies image processing algorithms to the scenes from each viewpoint to determine range information therefrom. The type of image processing algorithms required would be understood by one skilled in the art. The range information revealed in this way may be used to remove any ambiguity over which spot is which in the scene to allow fine ranging. The present invention may therefore use processing techniques looking at the difference in the two images to determine information about the scene using known stereo imaging techniques to augment the range information collected by analysing the positions of the projected spots.

Stereo information can also be used for edge and corner detection. If an edge falls between two spots the three dimensional ranging system will identify that adjacent spots have a significant difference in range and therefore there is an edge of some sort in the scene but it will not be able to exactly locate the edge. Stereo processing techniques can look at the difference in contrast in the image created by the edge in the two or more images and exactly identify the location of the edge or corner.

Indeed the location of features such as corners in the scene can be used as reference points in images from different viewpoints so as to allow a coherent model of the environment to be built up. For instance where the three dimensional imaging system may comprises two detectors in fixed relation to a spot projector in any one scene the location of the two detectors and the spot projector to one another is fixed and range information can be determined. However when the imaging system as a whole is moved the relative location of the new viewpoint to the last is needed in order to allow a model of the environment to be created. This could be done by position and orientation sensors on the imaging system or it could be done using information extracted from the scene itself. If the position of a corner in the scene is determined from both viewpoints the range information to that corner will give the relative location of the viewpoints.

If more than one viewpoint is used the viewpoints could be adapted to have different baselines. As mentioned the baseline between the detector and the illumination means has an effect on the range and the degree of ambiguity of the apparatus. One viewpoint could therefore be used with a low baseline so as to give a relatively low accuracy but unambiguous range to the scene over the distances required. This coarse range information could then be used to remove ambiguities from a scene viewed from a viewpoint with a larger baseline and hence greater accuracy.

Additionally or alternatively the baselines between the two viewpoints could be chosen such that if a spot detected in the scene from one viewpoint could correspond to a first set of possible ranges the same spot detected in another viewpoint could only correspond to one range within that first set. In other words imagine that a spot is detected in the scene viewed from the first viewpoint and could correspond to a first spot (1,0) at a first range R₁, a second spot (2,0) at a second range R₂, a third spot (3,0) at a third range R₃ and so on. The same spot could also give a possible set of ranges when viewed from the second viewpoint, i.e. it could be spot (1,0) at range r₁, spot (2,0) at range r₂, and so on. With appropriate set up of the two viewpoints and the illumination means when the two sets of ranges are compared it may be that there is only one possible range common to both sets and this therefore must be the actual range.

Where more than two viewpoints are used the baselines of at least two of the viewpoints may lie along different axes. For instance one viewpoint could be spaced horizontally relative to the illumination means and another viewpoint spaced vertically relative to the illumination means. The two viewpoints can collectively image the scene from different angles and so may reduce the problem of parts of the foreground of the scene obscuring parts of the background. The two viewpoints can also permit unambiguous determination of any spot as mentioned above but spacing the viewpoints on different axes can aid subsequent image processing of the image. Detection of edges for instance may be aided by different viewpoints as detection of a horizontal edge in a scene can be helped by ensuring the two viewpoints are separated vertically.

In one embodiment the imaging system may comprise at least three detectors arranged such that two detectors have viewpoints separated along a first axis and at least a third detector is located with a viewpoint not on the first axis. In other words the viewpoints of two of the detectors are separated in the x-direction and the viewpoint of a third camera is spaced from the first two detectors. Conveniently the system may comprise three detectors arranged in a substantially right angled triangle arrangement. The illumination means may conveniently form a rectangular or square arrangement with the three detectors. Such an arrangement gives a good degree of coverage of the scene, allowing unambiguous determination of projected spots by correlating the different images and guarantees two image pairs separated along orthogonal axes. Stereo imaging techniques could be used on the two sets of image pairs to allow all edges in the image to be analysed.

The apparatus may further comprise a plurality of illumination means arranged to illuminate the scene from different directions. The system may be adapted to periodically change the illumination means used to illuminate the scene so that only one illumination means is used at any time or the two or more illumination means may be used simultaneously and may project spots having different characteristics such as shape or colour so that the processor could work out which spots were projected by which illumination means. Having two illumination means gives some of the same benefits as described above as having two detectors. With one illumination means objects in the background may be in the shadow of objects in the foreground and hence will not be illuminated by the illumination means. Therefore it would not be possible to generate any range information. Having two illumination means could avoid this problem. Further if the detector or detectors were at different baselines from the various illumination means the differing baselines could again be used to help resolve range ambiguities.

The illumination means should ideally use a relatively low power source and produce a large regular array of spots with a large depth of field. A large depth of field is necessary when working with a large operating window of possible ranges as is a wide angle of projection, i.e. spots should be projected evenly across a wide angle of the scene and not just illuminate a small part of the scene. Preferable the illumination means projects the array of spots in an illumination angle of between 60° to 100°. Usefully the depth of field may be from 150 mm to infinity.

In a preferred embodiment therefore the illumination means comprises a light source arranged to illuminate part of the input face of a light guide, the light guide comprising a tube having substantially reflective sides and being arranged together with projection optics so as to project an array of distinct images of the light source towards the scene. The light guide in effect operates as a kaleidoscope. The preferred illumination means is that described in PCT patent application publication WO 2004/044523. Light from the source is reflected from the sides of the tube and can undergo a number of reflection paths within the tube. The result is that multiple images of the light source are produced and projected onto the scene. Thus the scene is illuminated with an array of images of the light source. Where the source is a simple light emitting diode the scene is therefore illuminated with an array of spots of light. The light guide kaleidoscope gives very good image replication characteristics and projects images of the input face of the light guide in a wide angle, i.e. a large number of spots are projected in all directions. Further the kaleidoscope produces a large depth of field and so delivers a large operating window.

The light guide comprises a tube with substantially reflective walls. Preferably the tube has a constant cross section which is conveniently a regular polygon. Having a regular cross section means that the array of images of the light source will also be regular which is advantageous for ensuring the whole scene is covered and eases processing. A square section tube is most preferred. Typically, the light guide has a cross sectional area in the range of a few square millimetres to a few tens of square millimetres, for instance the cross sectional area may be in the range of 1-50 mm² or 2-25 mm². As mentioned the light guide preferably has a regular shape cross section with a longest dimension of a few millimetres, say 1-5 mm. One embodiment as mentioned is a square section tube having a side length of 2-3 mm. The light guide may have a length of a few tens of millimetres, a light guide may be between 10 and 70 mm long. Such light guides can generate a grid of spots over an angle of 50-100 degrees (typically about twice the total internal angle within the light guide). Depth of field is generally found to be large enough to allow operation from 150 mm out to infinity. Other arrangements of light guide may be suitable for certain applications however.

The tube may comprise a hollow tube having reflective internal surfaces, i.e. mirrored internal walls. Alternatively the tube may be fabricated from a solid material and arranged such that a substantial amount of light incident at an interface between the material of the tube and surrounding material undergoes total internal reflection. The tube material may be either coated in a coating with a suitable refractive index or designed to operate in air, in which case the refractive index of the light guide material should be such that total internal reflection occurs at the material air interface.

Using a tube like this as a light guide results in multiple images of the light source being generated which can be projected to the scene to form the array of spots. The light guide is easy to manufacture and assemble and couples the majority of the light from the source to the scene. Thus low power sources such as light emitting diodes can be used. As the exit aperture can be small, the apparatus also has a large depth of field which makes it useful for ranging applications which require spots projected that are separated over a wide range of distances.

Either individual light sources may be used close to the input face of the light guide to illuminate just part of the input face or one or more light sources may be used to illuminate the input face of the light guide through a mask. Using a mask with transmissive portion for passing light to a part of the light guide can be easier than using individual light sources. Accurate alignment of the mask is required at the input face of the light guide but this may be easier than accurately aligning an LED or LED array.

Preferably where a mask is used the illumination means comprises a homogensier located between the light source and the mask so as to ensure that the mask is evenly illuminated. The light source may therefore be any light source giving an acceptable level of brightness and does not need accurate alignment. Alternatively an LED with oversized dimensions could be used to relax tolerances in manufacture/alignment.

The projection optics may comprise a projection lens. The projection lens may be located adjacent the output face of the light guide. In some embodiments where the light guide is solid the lens may be integral to the light guide, i.e. the tube may be shaped at the output face to form a lens.

All beams of light projected by the apparatus according to the present invention pass through the end of the light guide and can be thought of as originating from the point at the centre of the end face of the light guide. The projection optics can then comprise a hemispherical lens and if the centre of the hemisphere coincides with the centre of the light guide output face the apparent origin of the beams remains at the same point, i.e. each projected image has a common projection origin. In this arrangement the projector does not have an axis as such as it can be thought of a source of beams radiating across a wide angle. The preferred illumination means of the present invention is therefore quite different from known structured light generators. What matters for the ranging apparatus therefore is the geometrical relationship between the point of origin of the beams and the principal point of the imaging lens of the detector.

Preferably the projection optics are adapted so as to focus the projected array at relatively large distances. This provides a sharp image at large distances and a blurred image at closer distances. As discussed above the amount of blurring can give some coarse range information which can be used to resolve ambiguities. The discrimination is improved if the light source illuminates the input face of the light guide with a non circular shape, such a square. Either a square light source could be used or a light source could be used with a mask with square shaped transmissive portions.

In order to further remove ambiguity the light source may illuminate the input of the light guide with a shape which is not symmetric about the axes of reflection of the light guide. If the light source or transmissive portion of the mask is not symmetrical about the axis of reflection the image of the light source will be different to its mirror image. Adjacent spots in the projected array are mirror images and so shaping the light source or transmissive portions of the mask in this manner would allow discrimination between adjacent spots.

The apparatus may comprise more than one light source, each light source arranged to illuminate part of the input face of the light guide. Using more than one light source can improve the spot resolution in the scene. Preferably the more than one light sources are arranged in a regular pattern. The light sources may be arranged such that different arrangements of sources can be used to provide differing spot densities. For instance a single source could be located in the centre of the input face of the light guide to provide a certain spot density. A separate two by two array of sources could also be arranged on the input face and could be used instead of the central source to provide an increased spot density.

Alternatively the mask could be arranged with a plurality of transmissive portions, each illuminating a part of the input face of the light guide. In a similar manner to using multiple sources this can increase spot density in the scene. The mask may comprise an electro-optic modulator so that the transmission characteristics of any of the transmissive portions may be altered, i.e. a window in the mask could be switched from being transmissive to non-transmissive to effectively switch certain spots in the projected array on and off.

Where more than one light sources are used at least one light source could be arranged to emit light at a different wavelength to another light source. Alternatively when using a mask with a plurality of transmissive portions the different transmissive portions could transmit different wavelengths. Using sources with different wavelengths or transmissive windows operating at different wavelengths means that the array of spots projected into a scene will have differing wavelengths, in effect the spots will be different colours—although the skilled person will appreciate that the term colour is not meant to imply operation in the visible spectrum. Having varying colours will help remove ambiguity over which spot is which in the projected array.

Alternatively at least one light source could be shaped differently from another light source, preferably at least one light source having a shape that is not symmetric about a reflection axis of the light guide. Shaping the light sources again helps discriminate between spots in the array and having the shapes non symmetrical means that mirror images will be different, further improving discrimination as described above. The same effect may be achieved using a mask by shaping the transmissive portions appropriately.

At least one light source could be located within the light guide, at a different depth to another light source. The angular separation of the projected array from a kaleidoscope is determined by the ratio of its length to its width as will be described later. Locating at least one light source within the kaleidoscope effectively shortens the effective length of light guide for that light source. Therefore the resulting pattern projected towards the scene will comprise more than one array of spots having different periods. The degree of overlap of the spot will therefore change with distance from the centre of the array which can be used to identify each spot uniquely.

The skilled person will appreciate however that any illumination means which projects an array of distinct spots could be used in the present invention.

The invention will now be described by way of example only with reference to the following drawings of which;

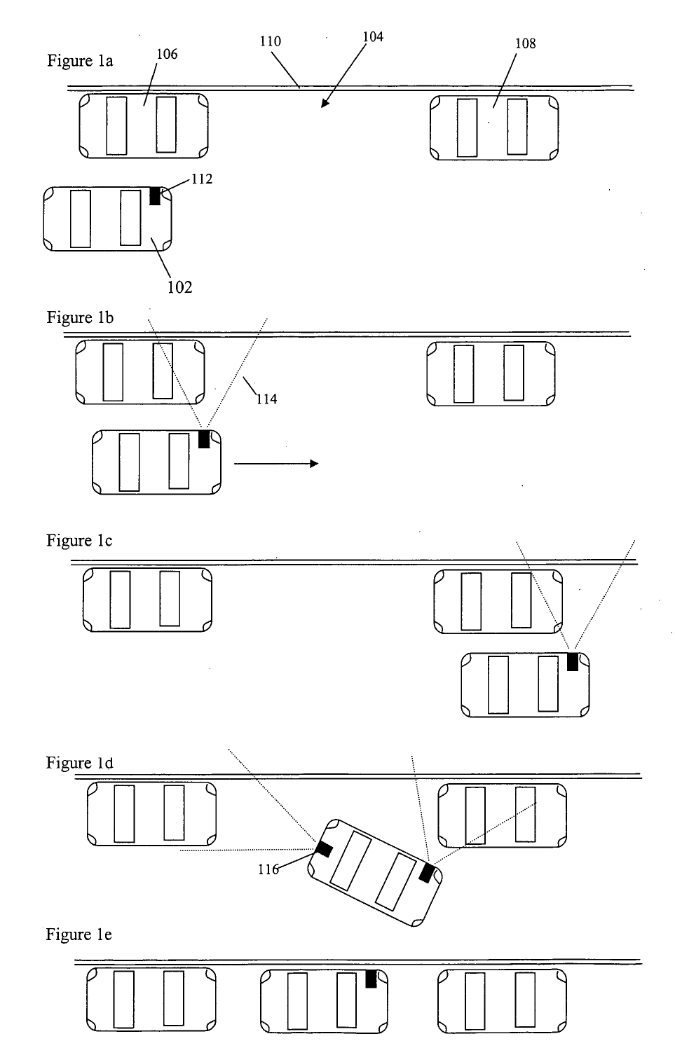

FIG. 1 shows illustrates how the present invention would be applied to a parking aid,

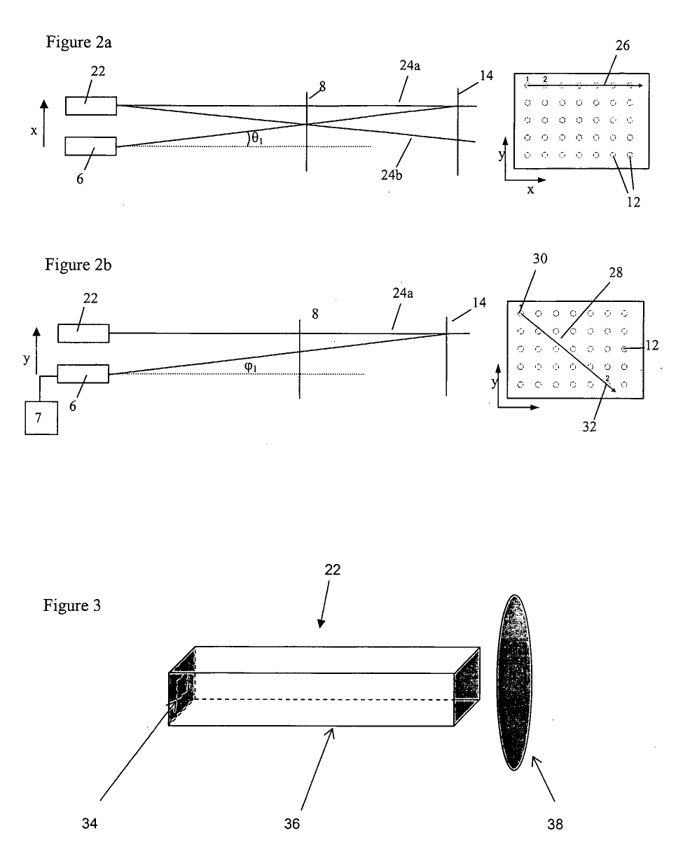

FIG. 2 shows a 3D camera used in the present invention,

FIG. 3 shows an illumination means used in the 3D camera shown in FIG. 2,

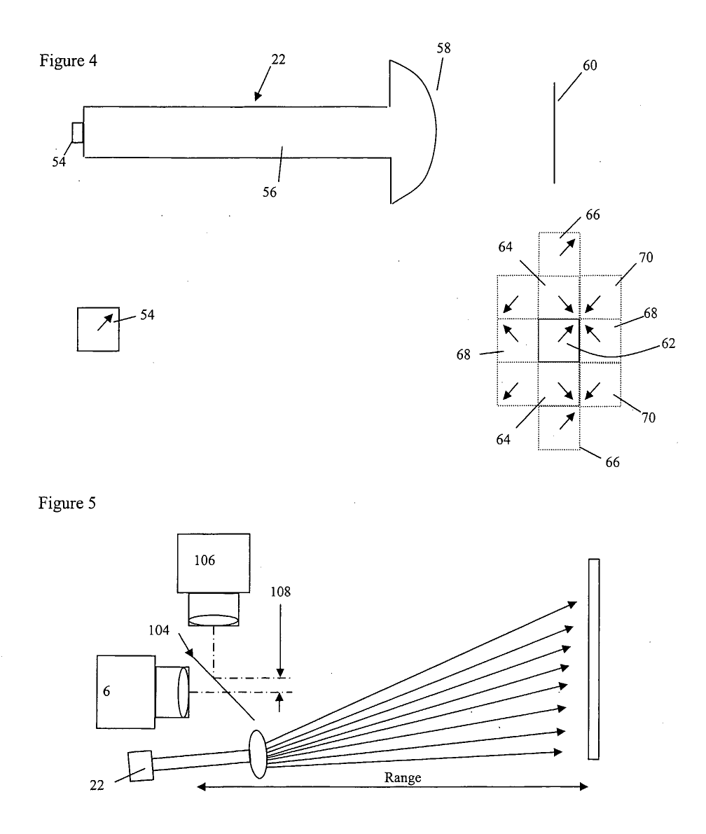

FIG. 4 shows an alternative illumination means,

FIG. 5 shows a 3D camera with two detector viewpoints,

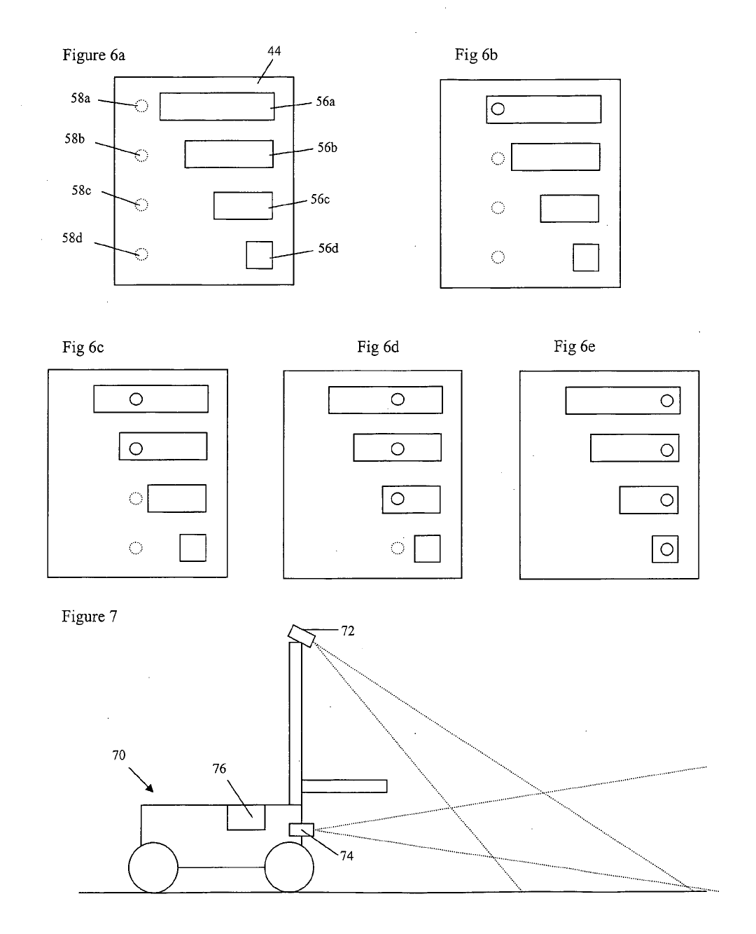

FIG. 6 shows a mask that can be used with a variant of the 3D camera technology to produce a simple proximity sensor or optical bumper, and

FIG. 7 shows a fork lift truck with a control system of the present invention.

One embodiment of the movement control sensor of the present invention is a parking aid for vehicles such as road vehicles. Referring to FIG. 1a a car 102 is shown that wants to park in a parking space generally indicated 104. The space is defined in this instance by parked vehicles 106 and 108 and the kerb 110 and the parking manoeuvre is a reverse parallel parking manoeuvre. However the invention is equally applicable to other parking arrangements such as parking in a garage.

The driver positions the car so that it is ready to drive past the parking space and activates the parking aid. This may entail indicating which side of the vehicle the relevant space is on. In some arrangements though there may be no need to activate the data acquisition step—this may be automatically performed continuously as part of general monitoring of the environment.

In any case when the parking aid is ready to acquire data the driver drives past the space as indicated in FIG. 1b. At least one sideways looking three-dimensional imaging camera unit 112 takes a plurality of images of the view from the side of the car as the car travels past the space. The field of view of the imager is indicated 114 and it can be seen that the successive images will give data about the range of parked car 106, the kerb 110 and parked car 108.

The parking aid processor takes all the data captured by the three-dimensional camera unit 112 and, as each image is acquired, records the relative position of the car by determining the amount of travel since the data acquisition was started. The processor could measure the amount of travel by incorporating a location sensor such as a GPS system but conveniently just links into the existing vehicle odometer system which works by measuring wheel rotation. For a parking aid it is usual that the vehicle will travel in generally a straight line when passing the space but any movement of the steering wheel could also be measured. Existing car systems tend to do these things already so integrating the parking sensor into the vehicle is relatively easy.

The processor of the 3D camera unit 112 not only works on the range data captured by the 3D camera as it traverses the space but also applies stereo imaging techniques to process the data from different frames. As the car moves the viewpoint of the camera changes and hence objects in the scene will move in the captured images. As the skilled person will appreciate, range information and location information about objects in a scene can be found using stereo imaging techniques. As the edges of objects often show the most contrast in an image and move between the two images stereo processing techniques are good at locating the edges of objects. Combined with the range information collected by the 3D camera the location of objects in the scene can then be modelled.

Movement of the car provides frame to frame images that can be processed using stereo processing techniques with a horizontal separation. It can also be useful to generate stereo information by looking at images separated along the vertical, for instance this can help in locating the kerb. The 3D camera unit 112 may therefore comprise two individual 3D cameras, or a 3D camera arrangement with two detectors, both looking generally in the same direction but having a certain predefined separation along a vertical axis.

The processor of the 3D camera unit therefore captures all the data from the scene and applies stereo processing techniques to identify the edges of objects in the scene. The range data is also used to help identify objects and the fill out the surface contours of the objects. In this way the processor can quickly generate a model of the parking space and the car in relation to it.

Once the car has passed the space, FIG. 1c, the parking aid could indicate that it has acquired enough information or the driver could indicate that the data acquisition step is finished. The model is then finalised using all the collected information. Once the complete model is available the processor may calculate one or more parking solutions. These could be presented to the driver by means of a visual display on the vehicle dashboard, for instance an animated sequence showing the proposed parking solution, and the driver could select the desired option as required or confirm that the parking step should proceed.

In a purely aiding system the processor may then relay instructions to the driver via an interface. For instance the processor could generate a series of instructions which are relayed to the driver via a computer generated speech module telling the driver when to reverse, when and how to steer etc. This could be aided by a visual display giving an indication of whether the car is on the right course.

During the parking step, FIG. 1d, the processor monitors travel of the car and the 3D camera also monitors the environment to constantly refine the parking model. An additional 3D camera on the rear of the car 116 also monitors the rear of the vehicle to provide more information about the location of the car 2 in relation to the parked vehicles.

These sensors also look for any changes to the environment, for instance a pedestrian or animal moving into the parking space or one of the parked cars moving. In this case a suitable warning may be activated and/or all movement of the car may be halted.

In an automated parking system the processor actually controls a drive unit which moves the car from the position shown in FIG. 1c to park the vehicle by applying the appropriate power and steering necessary. The driver maintains the ability to override at any time but, if not, the car will park itself—FIG. 1e. Again feedback from the 3D cameras 112 and 116 is used to constantly update the model of the environment and the car's relation thereto and to update the parking solution as required.

Thus the present invention provides a movement control system which can be used in aiding parking or even providing automated parking. The invention could however also be used as a safety monitor for all driving situations. In particular, blind spot detection for lorries and cars is relevant here. For instance 3D cameras could be located at all four corners of the vehicle to provide reasonable all round coverage of the environment around the vehicle. Locating the 3D cameras in the light clusters of vehicles may give appropriate coverage for a general driving aid system. Such a driving aid system could be used to monitor the range to vehicles either in front or behind of the car in question and provide warnings if suitable safety limits for the relevant speed are breached. In emergency situations the vehicle could even take preventative measures, for instance applying the brakes to prevent collision or even steering the vehicle away from an impact into an area determined to be free of any obstacles.

Although described above with reference to cars the invention is applicable to use on any vehicle which needs manoeuvring and in which there is danger of collision, for instance in manoeuvring aircraft in airports or lifting vehicles in warehouses etc. The invention would also allow lifting vehicles to determine how best to manipulate an object, for instance to pick up a pallet bearing a load in a warehouse and/or to deposit it appropriately. The same principles of the invention could also be used in guiding robotic arms etc.

The 3D camera used is a compact camera with high resolution, good range accuracy and real time processing of ranges. The camera used is that described in co-pending patent application PCT/GB2003/004898 published as WO 2004/044525 the contents of which is hereby incorporated by reference hereto.

FIG. 2 shows a suitable 3D imaging camera. A two dimensional spot projector 22 projects an array of spots 12 towards a scene. Detector 6 looks towards the scene and detects where in the scene the spots are located. The position of the spots in the scene depends upon the angle the spot makes to the detector which depends upon the range to the target. Thus by locating the position of the spot in the scene the range can be determined by processor 7.

The present invention uses a two dimensional array of spots to gain range information from the whole scene simultaneously. Using a two dimensional array of spots can lead to ambiguity problems as illustrated with reference to FIG. 2a. The spot projector 22 projects a plurality of angularly separated beams 24a, 24b (only two are shown for clarity). Where the scene is a flat target the image 10 the detector sees is a square array of spots 12. As can be seen from FIG. 2a though a spot appearing at a particular location in the scene, say that received at angle θ₁, could correspond to a first projected spot, that from beam 24b, being reflected or scattered from a target 8 at a first range or a second, different projected spot, that from beam 24a, being reflected or scattered from a target 14 at a more distant range. Each spot in the array can be thought of as having a locus in the scene of varying range. It can be seen that the locus for one spot, arrow 26, can overlap with the position of other spots, giving rise to range ambiguity.

One embodiment of the 3D camera avoids this problem by arranging the spot projector relative to the detector such that the array of spots is projected such that the loci of possible positions in the detected scene at varying range of adjacent spots do not overlap. FIG. 2b therefore shows the apparatus of the present invention from a side elevation. It can be seen that the detector 6 and spot projector 22 are separated in the y-direction as well as the x-direction. Therefore the y-position of a spot in the scene also varies with range, which has an effect on the locus of apparent spot motion. The arrangement is chosen such that the loci of adjacent spots do not overlap. The actual locus of spot motion is indicated by arrow 28. The same effect can be achieved by rotating the projector about its axis.

Another way of thinking of this would be to redefine the x-axis as the axis along which the detector and spot projector are separated, or at least the effective input/exit pupils thereof if mirrors or other diverting optical elements were used. The z-axis is the range to the scene to be measured and the y-axis is orthogonal. The detector therefore forms a two dimensional x-y image of the scene. In this co-ordinate system there is no separation of the detector and projector in the y-direction and so a spot projected by the projector at a certain angle in the z-y plane will always be perceived to be at that angle by the detector, irrespective of range, i.e. the spot will only appear to move in the detected scene in a direction parallel to the x-direction. If the array is therefore arranged with regard to the x-axis such that adjacent spots have different separations in the y-direction there will be no ambiguity between adjacent spots. Where the array is a square array of spots this would in effect mean tilting the array such that an axis of the array does not lie along the x-axis as defined, i.e. the axis by which the detector and spot projector are separated.

For wholly unambiguous determination of which spot is which the spot size, inter-spot gap and arrangement of the detector would be such that the locus of each spot did not overlap with the locus of any other spot. However for practical reasons of discrimination a large number of spots is preferable with a relatively large spot size and the apparatus is used with a large depth of field (and hence large apparent motion of a spot in the scene). In practice then the loci of different spots will sometimes overlap. As can be seen in FIG. 2b the locus of projected spot 30 does overlap with projected spot 32 and therefore a spot detected in the scene along the line of arrow 28 could correspond to projected spot 30 at one range or projected spot 32 at a different range. However the difference in the two ranges will be significant. In some applications the ranging system may only be used over a narrow band of possible ranges and hence within the operating window there may be no ambiguity. However for most applications it will be necessary to resolve the ambiguity. As the difference in possible ranges is relatively large however a coarse ranging technique could be used to resolve the ambiguity over which spot is being considered with the ranging system then providing accurate range information based on the location of uniquely identified spots.

In some cases it may be possible to assume a continuous, smooth surface in which case some of the possible ambiguities could be rejected on the grounds of excessive deviation in range.

In one embodiment spot projector 22 projects an array of square shaped spots which is focussed at relatively long range. If the processor sees square spots in the detected scene this means that the spots are substantially focussed and so the detected spot must consequently be one which is at relatively long range. However if the observed spot is at close range it will be substantially unfocussed and will appear circular. A focal length of 800 mm may be typical. Thus the appearance of the spot may be used to provide coarse range information to remove ambiguity over which spot has been detected with the location of the spot then being used to provide fine range information.

The detector 6 is a standard two dimensional CCD array, for instance a standard CCD camera although a CMOS camera could be used instead. The detector 6 should have sufficient resolution to be able to identify the spots and the position thereof in the scene. The detector 6 may be adapted to capture a visible image as well as detect the spots in the scene.

The spot projector may project spots in the visible waveband which may be detected by a camera operating in the visible band. However the spot projector may project spots at other wavelengths, for instance infrared or ultraviolet. The wavelength can be tailored for the particular application. Where the spot projector projects infrared spots onto the scene the detector used is a CCD camera with four elements to each pixel group. One element detects red light, another blue light and a third green light. The fourth element in the system is adapted to detect infrared light at the appropriate wavelength. Thus the readout from the RGB elements can be used to form a visible image free from any spots and the output of the infrared elements, which effectively contains only the infrared spots, provided to the processor to determine range. Where spots are projected at different wavelengths however as will be described later the detector must be adapted to distinguish between different infrared wavelengths, in which case a different camera may be preferred. The detector is not limited to working in the visible band either. For instance a thermal camera may be used. Provided the detector is able to detect the projected spots it doesn't matter whether the detector also has elements receiving different wavelengths.

In order to aid spot detection and avoid problems with ambient light the spot projector is adapted to project a modulated signal. The processor is adapted to filter the detected signal at the modulation frequency to improve the signal to noise ratio. The simplest realisation of this principle is to use a pulsed illumination, known as strobing or flash illumination. The camera captures one frame when the pulse is high. A reference frame is also taken without the spots projected. The difference of these intensity patterns is then corrected in terms of background lighting offsets. In addition a third reflectivity reference frame could be collected when synchronised to a uniformly illuminated LED flashlamp which would allow a normalisation of the intensity pattern.

A suitable spot projector 22 is shown in FIG. 3. A light source 34 is located adjacent an input face of a kaleidoscope 36. At the other end is located a simple projection lens 38. The projection lens is shown spaced from the kaleidoscope for the purposes of clarity but would generally be located adjacent the output face of the kaleidoscope.

The light source 34 is an infrared emitting light emitting diode (LED). As discussed above infrared is useful for ranging applications as the array of projected spots need not interfere with a visual image being acquired and infrared LEDs and detectors are reasonably inexpensive. However the skilled person would appreciate that other wavelengths and other light sources could be used for other applications without departing from the spirit of the invention.

The kaleidoscope is a hollow tube with internally reflective walls. The kaleidoscope could be made from any material with suitable rigidity and the internal walls coated with suitable dielectric coatings. However the skilled person would appreciate that the kaleidoscope could alternatively comprise a solid bar of material. Any material which is transparent at the wavelength of operation of the LED would suffice, such as clear optical glass. The material would need to be arranged such that at the interface between the kaleidoscope and the surrounding air the light is totally internally reflected within the kaleidoscope. This may be achieved using additional (silvering) coatings, particularly in regions that may be cemented with potentially index matching cements/epoxys etc. Where high projection angles are required this could require the kaleidoscope material to be cladded in a reflective material. An ideal kaleidoscope would have perfectly rectilinear walls with 100% reflectivity. It should be noted that a hollow kaleidoscope may not have an input or output face as such but the entrance and exit to the hollow kaleidoscope should be regarded as the face for the purposes of this specification.

The effect of the kaleidoscope tube is such that multiple images of the LED can be seen at the output end of the kaleidoscope.

The dimensions of the device are tailored for the intended application. Imagine that the LED emits light into a cone with a full angle of 90°. The number of spots viewed on either side of the centre, unreflected, spot will be equal to the kaleidoscope length divided by its width The ratio of spot separation to spot size is determined by the ratio of kaleidoscope width to LED size. Thus a 200 μm wide LED and a kaleidoscope 30 mm long by 1 mm square will produce a square grid of 61 spots on a side separated by five times their width (when focussed). The spot projector may typically be a few tens of millimetres long and have a square cross section with a side in the range of 2 to 5 mm long, say 3 to 4 mm square. For typical applications the spot projector is designed to produce an array of 40×30 spots or greater to be projected to the scene. A 40 by 30 array generates up to 1200 range points in the scene although 2500 range points may be preferred with the use of intersection lines allowing up to 10,000 range points.

Projection lens 38 is a simple singlet lens arranged at the end of kaleidoscope and is chosen so as to project the array of images of the LED 34 onto the scene. The projection geometry again can be chosen according to the application and the depth of field required but a simple geometry is to place the array of spots at or close to the focal plane of the lens. The depth of field of the projection system is important as it is preferable to have a large depth of field to enable the ranging apparatus to accurately range to objects within a large operating window. A depth of field of 150 mm out to infinity is achievable and allows useful operating windows of range to be determined.

As mentioned LED 34 may be square in shape and projection lens 38 could be adapted to focus the array of spots at a distance towards the upper expected range such that the degree of focus of any particular spot can yield coarse range information.

A spot projector as described has several advantages. The kaleidoscope is easy and inexpensive to manufacture. LEDs are cheap components and as the kaleidoscope efficiently couples light from the LED to the scene a relatively low power source can be used. The spot projector as described is therefore an inexpensive and reasonably robust component and also gives a large depth of focus which is very useful for ranging applications. A kaleidoscope based spot projector is thus preferred for the present invention. Further the spot projector of the present invention can be arranged so as to effectively have no specific axis. All beams of light emitted by the spot projector pass through the end of the kaleidoscope and can be thought of as passing through the centre of the output face. Where projection lens 38 is a hemispherical lens with its axis of rotation coincident with the centre of the output face then all beams of light appear to originate from the output face of the kaleidoscope and the projector acts as a wide angle projector.

The skilled person would appreciate however that other spot projectors could be used to generate the two dimensional array. For instance a laser could be used with a diffractive element to generate a diffraction pattern which is an array of spots. Alternatively a source could be used with projection optics and a mask having an array of apertures therein. Any source that is capable of projecting a discrete array of spots of light to the scene would suffice, however the depth of field generated by other means, LED arrays, microlens arrays, projection masks etc., has generally been found to be very limiting in performance.

An apparatus as shown in FIG. 2 was constructed using a spot projector as shown in FIG. 3. The spot projector illuminated the scene with an array of 40 by 30 spots. The operating window was 60° full angle. The spots were focussed at a distance of 1 m and the ranging device worked well in the range 0.5 m to 2 m. The detector was a 308 kpixel (VGA) CCD camera. The range to different objects in the scene were measured to an accuracy of 0.5 mm at mid range.

Before the apparatus as described above can be used to produce range data, it must first be calibrated. In principle, the calibration can be generated from the geometry of the system. In practice, it is more convenient to perform a manual calibration. This allows for imperfections in construction and is likely to produce better results.

After calibration the system is ready to determine range. The range finding algorithm consists of four basic stages. These are:

1 Normalise the image

2 Locate the spots in the image.

3 Identify the spots

4 Calculate range data

Normalisation

Since the camera has been filtered to select only light from the kaleidoscope, there should be a very low level of background light in the image. Therefore, any regions that are bright in comparison to the local background can be reasonably expected to be spots. However, the relative brightnesses of different spots will vary according to the range, position and reflectivity of the target. It is therefore convenient as a first step to normalise the image to remove unwanted background and highlight the spots.

The normalisation procedure consists of calculating the ‘average’ intensity in the neighbourhood of each pixel, dividing the signal at the pixel by its local average and then subtracting unity. If the result of this calculation is less than zero, the result is set to zero.

Spot Location

Spot location consists of two parts. The first is finding the spot. The second is determining its centre. The spot-finding routine maintains two copies of the normalised image. One copy (image A) is changed as more spots are found. The other (image B) is fixed and used for locating the centre of each spot.

As it is assumed that all bright features in the normalised images are spots, the spots can be found simply by locating all the bright regions in the image. The first spot is assumed to be near the brightest point in image A. The coordinates of this point are used to determine the centre of the spot and an estimate of the size of the spot (see below). The intensity in the region around the spot centre (based on the estimated spot size) is then set to zero in image A. The brightest remaining point in image A is then used to find the next spot and so on.

The spot-finding algorithm described above will find spots indefinitely unless extra conditions are imposed. Three conditions have been identified, which are used to terminate the routine. The routine terminates when any of the conditions is met. The first condition is that the number of spots found should not exceed a fixed value. The second condition is that the routine should not repeatedly find the same spot. This occurs occasionally under some lighting conditions. The third condition is that the intensity of the brightest point remaining in image A falls below a predetermined threshold value. This condition prevents the routine from finding false spots in the picture noise. Usually the threshold intensity is set to a fraction (typically 20%) of the intensity of the brightest spot in image B.

The centre of each spot is found from image B using the location determined by the spot-finding routine as a starting point. A sub-image is taken from image B, centred on that point. The size of the sub-image is chosen to be slightly larger than the size of a spot. The sub-image is reduced to a one-dimensional array by adding the intensity values in each column. The array (or its derivative) is then correlated with a gaussian function (or it's derivative) and the peak of the correlation (interpolated to a fraction of a pixel) is defined as the centre of the spot in the horizontal direction. The centre of the spot in the orthogonal direction is found in a similar manner by summing rows in the sub-image instead of columns.

If the centre of the spot determined by the procedure above is more than two pixels away from the starting point, the procedure should be repeated iteratively, using the calculated centre as the new starting point. The calculation continues until the calculated position remains unchanged or a maximum number of iterations is reached. This allows for the possibility that the brightest point is not at the centre of the spot. A maximum number of iterations (typically 5) should be used to prevent the routine from hunting in a small region. The iterative approach also allows spots to be tracked as the range to an object varies, provided that the spot does not move too far between successive frames. This feature is useful during calibration.

Having found the centre of the spot, the number of pixels in the sub-image with an intensity greater than a threshold value (typically 10% of the brightest pixel in the sub-image) is counted. The spot size is defined as the square root of this number, and may be used for additional coarse range information.

The outcome of the spot locating procedure is a list of (a,b) coordinates, each representing a different spot.

Spot Identification

The range to each spot can only be calculated if the identity of the spot can be determined. The simplest approach to spot identification is to determine the distance from the spot to each spot track in turn and eliminate those tracks that lie outside a pre-determined distance (typically less than one pixel for a well-calibrated system). This approach may be time-consuming when there are many spots and many tracks. A more efficient approach is to calculate the identifier for the spot and compare it with the identifiers for the various tracks. Since the identifiers for the tracks can be pre-sorted, the search can be made much quicker. The identifier is calculated in the same way as in the calibration routine.

Once candidate tracks have been identified, it is necessary to consider the position of the spot along the track. If the range of possible distances is limited, (e.g. nothing can be closer than, say, 150 mm or further than 2500 mm) then many of the candidate tracks will be eliminated since the calculated range will be outside possible boundaries. In a well-adjusted system, at most two tracks should remain. One track will correspond to a short range and the other to a much longer range.

A final test is to examine the shape of the spot in question. As described the projector 22 produces spots that are focussed at long ranges and blurred at short ranges. Provided that the LEDs in the projector have a recognisable shape (such as square) then the spots will be round at short distances and shaped at long distances. This should remove any remaining range ambiguities.

Any spots that remain unidentified are probably not spots at all but unwanted points of light in the scene.

Range Calculation

Once a spot has been identified, its range can be calculated. In order to produce a valid 3-dimensional representation of the scene it is also necessary to calculate x and y-coordinates. These can simply be derived from the camera properties. For example, for a camera lens of focal length f with pixel spacing p, the x- and y-coordinates are simply given by:
x=zap/f, y=zbp/f
where a and b are measured in pixel coordinates.

The embodiment described above was adjusted so as to have minimal ambiguity between possible spots and use focus to resolve the ambiguity. Other means of resolving ambiguity may be employed however. In one embodiment of the invention the apparatus includes a spot projector generally as described with reference to FIG. 3 but in which the light source is shaped so as to allow discrimination between adjacent spots. Where the light source is symmetric about the appropriate axes of reflection the spots produced by the system are effectively identical. However where a non symmetrically shaped source is used adjacent spots will be distinguishable mirror images of each other. The principle is illustrated in FIG. 4.

The structured light generator 22 comprises a solid tube of clear optical glass 56 having a square cross section. A shaped LED 54 is located at one face. The other end of tube 56 is shaped into a hemispherical projection lens 58. Kaleidoscope 56 and lens 58 are therefore integral which increases optical efficiency and eases manufacturing as a single moulding step may be used. Alternatively a separate lens could be optically cemented to the end of a solid kaleidoscope with a plane output face.

For the purposes of illustration LED 54 is shown as an arrow pointing to one corner of the kaleidoscope, top right in this illustration. The image formed on a screen 60 is shown. A central image 62 of the LED is formed corresponding to an unreflected spot and again has the arrow pointing to the top right. Note that in actual fact a simple projection lens will project an inverted image and so the images formed would actually be inverted. However the images are shown not inverted for the purposes of explanation. The images 64 above and below the central spot have been once reflected and therefore are a mirror image about the x-axis, i.e. the arrow points to the bottom right. The next images 66 above or below however have been twice reflected about the x-axis and so are identical to the centre image. Similarly the images 68 to the left and right of the centre image have been once reflected with regard to the y-axis and so the arrow appears to point to the top left. The images 70 diagonally adjacent the centre spot have been reflected once about the x-axis and once about the y-axis and so the arrow appears to point to the bottom left. Thus the orientation of the arrow in the detected image gives an indication of which spot is being detected. This technique allows discrimination between adjacent spots but not subsequent spots.

In another embodiment more than one light source is used. The light sources could be used to give variable resolution in terms of spot density in the scene, or could be used to aid discrimination between spots, or both.

For example if more than one LED were used and each LED was a different colour the pattern projected towards the scene would have different coloured spots therein. The skilled person would appreciate that the term colour as used herein does not necessarily mean different wavelengths in the visible spectrum but merely that the LEDs have distinguishable wavelengths.

The arrangement of LEDs on the input face of the kaleidoscope effects the array of spots projected and a regular arrangement is preferred. To provide a regular array the LEDs should be regularly spaced from each other and the distance from the LED to the edge of the kaleidoscope should be half the separation between LEDs.

In another embodiment an arrangement of LEDs may be used to give differing spot densities. For example thirteen LEDs may arranged on the input face of a square section kaleidoscope. Nine of the LEDs are arranged in a regular 3×3 square grid pattern with the middle LED centred in the middle of the input face. The remaining four LEDs are arranged as they would be to give a regular 2×2 grid. The structured light generator can then be operated in three different modes. Either the central LED could be operated on its own, this would project a regular array of spots as described above, or multiple LEDs could be operated. For instance, the four LEDs arranged in the 2×2 arrangement could be illuminated to give an array with four times as many spots produced than with the centre LED alone.

The different LED arrangements could be used at different ranges. When used to illuminate scenes where the targets are at close range the single LED may generate a sufficient number of spots for discrimination. At intermediate or longer ranges however the spot density may drop below an acceptable level, in which case either the 2×2 or 3×3 array could be used to increase the spot density. As mentioned the LEDs could be different colours to improve discrimination between different spots.

Where multiple sources are used appropriate choice of shape or colour of the sources can give further discrimination.

Where multiple sources are used the sources may be arranged to be switched on and off independently to further aid in discrimination. For instance several LEDs could be used, arranged as described above, with each LED being activated in turn. Alternatively the array could generally operate with all LEDs illuminated but in response to a control signal from the processor which suggests some ambiguity could be used to activate or deactivate some LEDs accordingly.

All of the above embodiments using shaped LEDs or LEDs or different colours can be combined with appropriate arrangement of the detector and spot projector such that where the locus of a spot overlaps with another spot the adjacent spots on that locus have different characteristics. For example, referring back to FIG. 2b it can be seen that the arrangement is such that the locus of spot 30 overlaps with spot 32, i.e. a spot detected at the position of spot 32 shown could correspond to projected spot 32 reflected from a target at a first range or projected spot 30 reflected from a target at a different range. However imagine that the spot projector of FIG. 5 were used. It can been seen that if projected spot 30 were an arrow pointing to the upper right then projected spot 32, but virtue of its position in the array, would be an arrow pointing to the upper left. Thus there would be no ambiguity over which spot was which as the direction of the arrow would indicate which spot was being observed.

In an alternative embodiment of spot projector the light source illuminates the kaleidoscope through a mask. The kaleidoscope and projection lens may be the same as described above but the light source may be a bright LED source arranged to illuminate the mask through a homogeniser. The homogeniser simply acts to ensure uniform illumination of the mask and so may be a simple and relatively inexpensive plastic light pipe. Alternatively larger LEDs, which can be placed less accurately, may be an efficient and low cost solution.

The mask is arranged to have a plurality of transmissive portions, i.e. windows, so that only part of the light from the LED is incident on the input face of the kaleidoscope. Each aperture in the mask will act as a separate light source in the same manner as described above and so the kaleidoscope will replicate an image of the apertures in the mask and project an array of spots onto the scene.

A mask may be fabricated and accurately aligned with respect to the kaleidoscope more easily than an LED array which would require small LEDs. Thus the manufacture of the spot projector may be simplified by use of a mask. The transmissive portions of the mask may be shaped so as to act as shaped light sources as described above. Therefore the mask may allow an array of spots of different shapes to be projected and shaping of the transmissive portions of the mask may again be easier than providing shaped light sources.

Further the different transmissive portions of the mask may transmit at different wavelengths, i.e. the windows may have different coloured filters.

Some of the transmissive windows may have a transmission characteristic which can be modulated, for instance the mask may comprise an electro-optic modulator. Certain windows in the mask may then be switched from being transmissive to non transmissive so as to deactivate certain spots in the projected array. This could be used in a similar fashion to the various arrays described to give different spot densities or could be used to deactivate certain spots in the array so as to resolve a possible ambiguity.

In a further embodiment light sources are arranged at different depths within the kaleidoscope. The angular separation of adjacent beams from the kaleidoscope depends upon the ratio between the length and width of the kaleidoscope as discussed above. For instance the kaleidoscope tube may be formed from two pieces of material. A first LED is located at the input face of the kaleidoscope as discussed above. A second LED is located at a different depth within the kaleidoscope, between the two sections of the kaleidoscope. The skilled person would be well aware of how to join the two sections of kaleidoscope to ensure maximum efficiency and locate the second LED between the two sections.

The resulting pattern contains two grids with different periods, the grid corresponding to the second LED partially obscuring the grid corresponding to the first LED. The degree of separation between the two spots will vary with distance from the centre spot. The degree of separation or offset of the two grids could then be used to identify the spots uniquely. The LEDs could be different colours as described above to improve discrimination.

It should be noted that the term spot should be taken as meaning a point of light which is distinguishable. It is not intended to limit to an entirely separate area of light. For instance a cross shaped LED may be used on the input face of the kaleidoscope. The LED extends to the side walls of the kaleidoscope and so the projected pattern will be a grid of continuous lines. The intersection of the lines provides an identifiable area or spot which can be located and the range determined in the same manner as described above.

Once the range to the intersection has been determined the range to any point on the line passing through that intersection can be determined using the information gained from the intersection point. Thus the resolution of the system is greatly magnified. Using the same 40×30 projection system described above but with the LED arrangement shown in FIG. 10 there are 1200 intersection points which can be identified to a system with far more range points. The apparatus could be used therefore with the processor arranged to identify each intersection point and determine the range thereto and then work out the range to each point on the connecting lines. Alternatively the cross LED could comprise a separate centre portion which can be illuminated separately. Illumination of the central LED portion would cause an array of spots to be projected as described earlier. Once the range to each spot had been determined the rest of cross LED could be activated and the range to various points on the connecting lines determined. Having the central portion only illuminated first may more easily allow ambiguities to be resolved based on shaped of the projected spots. An intersecting array of lines can also be produced using a spot projector having a mask.

As mentioned above it can be beneficial to view the scene from two different viewpoints. FIG. 5 shows a system where two CCD cameras 6, 106 are used to look at the scene. Spot projector 22 may be any of the spot projectors described above and projects a regular array of spots or crosses. CCD camera 6 is the same as described above with respect to FIG. 2. A second camera 106 is also provided which is identical to camera 6. A beamsplitter 104 is arranged so as to pass some light from the scene to camera 6 and reflect some light to camera 106. The arrangement of camera 106 relative to beamsplitter 104 is such that there is a small difference 108 in the effective positions of the two cameras. Each camera therefore sees a slightly different scene. If the camera positions were sufficiently far removed the beamsplitter 104 could be omitted and both cameras could be oriented to look directly towards the scene but the size of components and desired spacing may not allow such an arrangement.

The output from camera 6 could then be used to calculate range to the scene as described above. Camera 106 could also be used to calculate range to the scene. The output of each camera could be ambiguous in the manner described above in that a detected spot may correspond to any of one of a number of possible projected spots at different ranges. However as the two cameras are at different spacings the set of possible ranges calculated for each detected spot will vary. Thus for any detected spot only one possible range, the actual range, will be common to the sets calculated for each camera.

When camera 6 is located with a very small baseline, i.e. separation of line of sight, from the spot projector the corresponding loci of possible positions of spots in the scene at different ranges are small. Referring back to FIG. 2a it can be seen that if the separation from the detector 6 to the spot projector 22 is small the apparent movement in the scene of a spot at different ranges will not be great. Thus the locus will be small and there may be no overlap between loci of different spots in the operating window, i.e. no ambiguity. However a limited locus of possible positions means that the system is not as accurate as one with a greater degree of movement. For a system with reasonable accuracy and range a baseline of approximately 60 mm would be typical. Referring to FIG. 9 then if camera 6 is located close to the line of sight of the spot projector the output from camera 6 would be a non ambiguous but low accuracy measurement. Camera 106 however may be located at an appropriate baseline from the spot projector 22 to give accurate results. The low accuracy readings from the output from camera 6 could be used to resolve any ambiguity in the readings from camera 106.

Alternatively the outputs from the two camera themselves could be used to give coarse ranging. If the arrangement is such that the baseline between the cameras is small, say about 2 mm, the difference in detected position of a spot in the two cameras can be used to give a coarse estimate of range. The baseline between either camera and the projector may be large however. The advantage of this configuration is that the two cameras are looking at images with very small differences between them. The camera to projector arrangement needs to determine spot location by correlation of the recovered spot with a stored gaussian intensity distribution to optimise the measurement of the position of the spot. This is reasonable but never a perfect match as the spot sizes change with range and reflectivity may vary across the spot. Surface slope of the target may also effect the apparent shape. The camera to camera system looks at the same, possibly distorted spot, from two viewpoints which means that the correlation is always nearly a perfect match. This principle of additional camera channels to completely remove ambiguity or add information can be realised to advantage using cameras to generate near orthogonal baselines and/or as a set of three to allow two orthogonal stereo systems to be generated. The combination of a spot projecting 3D camera with a feature detecting stereo/trinocular camera can provide a powerful combination.

For some applications, or in some modes of operation, full range information about the scene may not be required and all that might be needed is a proximity alert. In which case the 3D camera described above may be used without the need for any intensive processing to produce a model of the environment. Simply giving warnings about objects being within certain range limits may be sufficient. For instance as a simple sensor for preventing collision, e.g. for aircraft wingtips, it may be sufficient to use a 3D camera of the present invention simply indicate the range to the nearest object or give an indication if an object is getting close to the wingtip, e.g. an audible bleeping alarm with a frequency dependent on range. In which case the processor may simply be adapted to determine range and either give an indication of the closest range or generate a warning signal based on certain threshold ranges. Alternatively the 3D camera could be used as part of a system operable in two modes, a simple movement mode where all that is needed is collision avoidance type information and an interaction mode where full 3D information is needed to allow interaction with the environment, such as manipulating objects.

Where only a simple proximity sensor is required a variation of the 3D camera technology described above can be used. This variant has a similar spot projector and detector as shown in FIG. 2 but a mask is placed in front of the detector. The mask has apertures therein to ensure that the detector can only see spots at certain ranges. As can be seen from FIG. 2 a spot in the scene appears at different positions in the scene as different ranges. The apertures in the mask can be positioned so that a spot only appears in the aperture, and hence appears to the detector, when reflected from a target at a certain range. Therefore the mere presence of a spot gives an indication of a range bracket and so range threshold information is given without the need for any processing. Thus processor 7 in FIG. 2 can be replaced with a simple threshold detector. A proximity sensor of this type is described in co-pending application no PCT/GB2003/004861 published as WO 2004/044619. A more flexible solution does not actually require the presence of a physical mask. A binary mask can be programmed which is multiplied with the bitmap image output by the detector array to generate the same effect. The multiplication is a very simple step which requires minimal processing and the result still allows very simple processing to be applied. For the purposes of this specification a mask shall be taken to mean either a physical optical barrier or notional mask applied to the detector output.

A mask that allows discrimination between several groups of ranges is shown in FIG. 6.

The mask is a sheet of opaque material 44 having an array of apertures therein. Four apertures 56a-d are shown for clarity although in reality the mask may be made up of repeating groups of these apertures. The apertures are sized and shaped so that each aperture could show a spot reflected from a target at a predetermined range. However the apertures are differently sized and are extended by different amounts in the direction of apparent movement of the spots in the scene with varying range. FIGS. 6a to 6e show the positions of four spots 58a-d in the projected array reflected from a target at progressively closer range.

In FIG. 6a the target is far away and none of the spots 58 a-d are visible through the apertures. If the target moves closer however spot 58a becomes visible through aperture 56a. None of the other spots 58 b-d are visible through the other apertures however. In FIG. 5c the target has moved closer still and now spots 58a and 58b are visible through their respective apertures 56a and 56b but the other two spots are not yet visible. FIGS. 6d and 6e shows that as the target moves closer still spots 58c becomes visible followed by spot 58d.

It can therefore be seen that the detector will see five distinct intensity levels as a target moves closer corresponding to no spots being visible or one, two, three or four spots being visible. Therefore the different intensity levels could be used to give an indication that a target is within a certain range boundary. Note that this embodiment, using a discriminating threshold level to determine the range, will only generally be appropriate where the targets are known to be of standard reflectivity and will fill the entire field of view at all ranges. If targets were different sizes a small target may generate a different intensity to a larger target and a more reflective target would generate a greater intensity than a less reflective one.

Where target consistency is not known several detectors could be used, each having a mask arranged so as to pass light reflected or scattered from spots at different ranges, i.e. each detector would have a single comparison to determine whether an object was within a certain range but the range for each detector could be different.

Alternatively the embodiment described with reference to FIG. 6 could be used with a means of determining which spots contribute to the overall intensity on the detector. This could be achieved by modulating the spots present in the scene. For instance imagine each of the four spots in FIGS. 6a-e was transmitted at a different modulated frequency. The signal from the detector would then have up to four different frequency components. The detected signal could then be processed in turn for each frequency component to determine whether there is any signal through the corresponding family of apertures. In other words if spot 58a were modulated at frequency f₁ identification of a signal component in the detected signal at f₁ would indicate that a target was close enough that a spot appeared in aperture 56a. Absence of frequency component f₂ corresponding to spot 58b would mean that the situation shown in FIG. 6b applied. Thus could be detected irrespective of whether an object is large or small or reflective or not as it is the detection of the relevant frequency component which is indicative of range.

Using a spot projector as shown in FIG. 3 to produce such a modulated output would simply involve replacing the single LED 34 with a row of 4 LEDs each modulated at a different frequency. Modulating the frequency in this way thus allows incremental range discrimination but reduces the density of coverage to the scene as each spot can only be used for one of the possible ranges. Alternatively where an input mask is used for the input to the kaleidoscope the mask may comprise a plurality of windows each window comprising a modulator operating at a different frequency.

FIG. 7 shows a fork lift truck 70 having two 3D cameras mounted thereon. A first camera 72 is mounted on the top of the truck and is directed to look at the area in front of the truck. A second camera 74 is mounted towards the base of the truck looking forward. The fork lift truck is automated and is controlled by controller 76 which can operate the truck in two modes.

The first mode is a movement mode and is used for moving the truck from one specified location to another, for instance if a particular item from a warehouse is needed a signal may be sent to the truck to fetch the item and take it to a loading bay. The controller would then direct the truck from its current location to the area of the warehouse where the required item is stored. In movement mode the truck will be move along the aisles in the warehouse where no obstacles would be expected. The truck may be provided with an internal map of the warehouse and position locators so that the controller can control movement of the truck to the specified location. Therefore detailed three dimensional modelling of the environment is not required. However to detect any people in the path of the truck or to detect any obstacles such as a fallen crate the three dimensional cameras operate in proximity sensor mode as described above allowing fast identification of any possible obstacles. In movement mode the top mounted camera 72 has a mask applied (a binary mask applied to the output) such that spots reflected from a level floor in front of the truck appear in the apertures of the mask. Any significant deviation in floor level or obstacle in the path of the projected spots will cause the reflected spots to move to a masked part of the scene and the change in intensity can be detected. The lower camera 74 is masked so that for a clear path no spots are visible but if an object is within say 0.5 m of the truck spots will appear in the unmasked areas. Again this can be detected by a simple change in intensity.

Once the truck arrives at its location the controller switches to interaction mode and a mask is no longer applied to the output of the two cameras and full processing of the scene is applied. Each camera 72, 74 comprises a spot projector and two detectors spaced apart along the horizontal axis allowing for three dimensional ranging and stereo processing techniques to be applied. The vertical separation of the two cameras also allows for stereo processing in the vertical sense. The edges of the target object and features such as holes in the pallet can be identified. If necessary the controller may move the truck past the target area to give other viewpoints to complete the model. Once the model is complete the controller can set the forks of the truck to the right height and manoeuvre the truck to engage with the object and lift it clear. Once the object is securely on the lifting platform the controller may switch back to movement mode and move the truck to the loading area.

At the loading area the controller switches again to interaction mode, acquires a model of the area and deposits the object according to its original instructions.

If an obstacle is encountered on the way in movement mode the controller may adopt various strategies. It may stop the truck, sound an audible alarm and wait a short time to see if the obstacle moves—that is a person moves out of the way—in which case the truck can continue its journey. If the obstacle does not move it may be assumed to be a blockage, in which case the truck may send a notification signal to a control room and determine another route to its destination or determine if a route past the obstacle exists, possibly by switching to interaction mode to model the blockage.

1. A movement control system comprising at least one three-dimensional imaging apparatus adapted to image an environment and a processor for analysing the image so at to create a model of the environment and generate a movement control signal based on the created model wherein the three-dimensional imaging apparatus comprises an illumination means for illuminating a scene with a projected two dimensional array of light spots, a detector for detecting the location of spots in the scene and a spot processor adapted to determine, from the detected location of a spot in the scene, the range to that spot.

2. A movement control system as claimed in claim 1 adapted to be applied to a vehicle.

3. A movement control system as claimed in claim 1 wherein the at least one three-dimensional imaging apparatus is adapted to acquire three dimensional images of the environment at a plurality of different positions and the processor is adapted to process images from the different positions so as to create the model of the environment.

4. A movement control system as claimed in claim 1 wherein the three dimensional imaging apparatus has at least two detectors each detector acquiring an image of the scene from a different position.

5. A movement control system as claimed in claim 1 comprising a plurality of three dimensional imaging apparatuses arranged at different locations on the vehicle to provide images acquired at different positions.

6. A movement control system as claimed in claim 4 wherein the processor is adapted to merge the data from the images acquired at different positions.

7. A movement control system as claimed in claim 4 wherein the processor is also adapted to apply stereo image processing techniques to images from different positions in creating the model of the environment.

8. A movement control system as claimed in claim 7 wherein the processor is adapted to use stereo processing techniques to perform edge/corner detection.

9. A movement control system as claimed in claim 4 wherein the system further comprises a means of determining the relative location of the three-dimensional imaging apparatus as each image is acquired and the processor is adapted to use the information about relative location in creating the model.

10. A movement control system as claimed in claim 9 wherein the means of determining the relative location of the three dimensional imaging apparatus comprises at least one position sensor.

11. A movement control system as claimed in claim 9 wherein the means of determining the relative location of the three dimensional imaging apparatus is the processor which is adapted to identify reference objects in the images from each viewpoint.

12. A vehicle positioning system comprising a three-dimensional imaging apparatus arranged acquire a plurality of three dimensional images of a target area as the vehicle passes the target area and a processor adapted to process the images from the different positions so as to create the model of the environment in relation to the vehicle and determine how to position the vehicle with respect to the target area.

13. A vehicle positioning system as claimed in claim 12 where the system is a parking system, the target area is a parking area and the positioning system determines how to park the vehicle in the parking area.

14. A vehicle positioning system as claimed in claim 12 further comprising a user interface and wherein the processor generates a control signal which gives vehicle control instructions via the interface.

15. A vehicle positioning system as claimed in claim 12 further comprising a drive unit for controlling vehicle movement and the processor controls the drive unit so as to position to vehicle.

16. A vehicle positioning system as claimed in claim 12 wherein as the vehicle is positioned the processor processes information from the three-dimensional imaging apparatus and updates the model of the environment.

17. A vehicle having a parking system as claimed in claim 12.

18. A docking control system for a moveable platform comprising a three-dimensional imaging apparatus arranged acquire three dimensional images of an environment from a plurality of different positions and a processor adapted to process the images from the different positions so as to create the model of the environment in relation to the moveable platform and provide a control signal to a drive means of the moveable platform so as to dock the moveable platform with the environment.

19. A vehicle driving aid comprising a movement control system as claimed in claim 1 wherein at least one 3D imager is adapted to image a vehicle blind spot and the movement control signal is a warning that an object has entered the vehicle blind spot.

20. A robotic arm control unit comprising a three-dimensional imaging apparatus arranged acquire three dimensional images of an environment from a plurality of different positions and a processor adapted to process the images from the different positions so as to create the model of the environment in relation to the robotic arm and provide a control signal to a drive means of the robotic arm to either engage an object or accurately place an object.

21. A robotic arm control unit as claimed in claim 20 wherein the processor moves at least part of the arm to scan the three dimensional imaging apparatus relative to the environment to acquire images from a plurality of different positions.

22. A robotic arm control unit as claimed in claim 20 wherein the three-dimensional imaging apparatus comprises an illumination means for illuminating a scene with a projected two dimensional array of light spots, a detector for detecting the location of spots in the scene and a spot processor adapted to determine, from the detected location of a spot in the scene, the range to that spot.

23. A robotic arm control unit as claimed in claim 22 wherein the three dimensional imaging apparatus comprises at least two detectors, each detector acquiring an image of the scene from a different position.

24. A robotic arm control unit as claimed in claim 20 wherein the processor applies stereo image processing techniques to the images acquired from different position.

25. A movement control system for a vehicle operable in two modes, a movement mode in which a proximity sensor operates to detect any objects within the path of the vehicle, and an interaction mode in which a three dimensional ranging apparatus determines range information about a target area to form a model of the target area.

26. A movement control system as claimed in claim 25 wherein, in movement mode, the three dimensional ranging apparatus operates as the proximity sensor.

27. A movement control system as claimed in claim 25 wherein the three-dimensional imaging apparatus comprises an illumination means for illuminating a scene with a projected two dimensional array of light spots, a detector for detecting the location of spots in the scene and a spot processor adapted to determine, from the detected location of a spot in the scene, the range to that spot.

28. A movement control system as claimed in claim 27 wherein the three dimensional imaging apparatus comprises at least two detectors, each detector having a different viewpoint.

29. A movement control system as claimed in claim 1 comprising at least two three dimensional imaging apparatuses each having a different viewpoint.

30. A movement control system as claimed in claim 28 wherein the processor applies stereo imaging techniques to the images acquired from different viewpoints.
